(19) United States
(12) Patent Application Publication
(10) Pub. No.: US 2010/0233369 A1
(43) Pub. Date: Sep. 16, 2010

(54) Method Of Forming A Paste Pattern

(75) Inventors: Dietmar Krause, Zurich (CH); Christian Saner, Zurich (CH)

Correspondence Address: Nixon Peabody LLP, P.O. Box 60610, Palo Alto, CA, 94306, US

(73) Assignee: ESEC AG, Cham (CH)

(21) Appl. No.: 12/705,354

(22) Filed: Feb. 12, 2010

Related U.S. Application Data
(60) Provisional application No. 61/152,813, filed on Feb. 16, 2009.

(51) Int. Cl. B05D 1/00

(52) U.S. Cl. 427/256

(57) ABSTRACT

A method of forming a paste pattern on a surface of a body comprises moving a writing nozzle delivering the paste relatively to the surface of the body along a sequence of segment lines following each other. Each segment line has a start point and an end point and at least one of the segment lines has a section with a curvature. The curvature of each segment line having a section with a curvature changes continuously. Said moving comprises stopping the writing nozzle at the end point of each segment line.

### PRIORITY CLAIM

Applicant hereby claims priority under 35 U.S.C §119 from U.S. provisional application No. 61/152,761 filed Feb. 16, 2009, the disclosure of which is herein incorporated by reference.

### FIELD OF THE INVENTION

The invention relates to a method of forming a paste pattern by depositing paste according to a predefined writing pattern on the surface of a body.

### BACKGROUND OF THE INVENTION

Within the context of the present description the term “paste” is to be understood as a viscous or semi-fluid material the viscosity of which is so high that the paste may be applied to the surface of a body in the form of a path, i.e. in a sequence of segment lines, on the surface. Such a paste may be for example an epoxy adhesive.

The body on which the paste is deposited may be for example a leadframe or a semiconductor chip.

Within the context of the present description, the terms “writing pattern” and “writing path” are used to refer to the writing process per se, whereas the term “paste pattern” is to be understood as the shape or pattern of the deposited paste.

A device for depositing a paste pattern usually comprises a paste reservoir and a paste delivery device that is capable of continuously delivering paste. The paste delivery device may comprise for example a nozzle. Furthermore, means for moving the paste delivery device relatively to the surface of the body are necessary. Either the body which is to receive the paste or the paste delivery device or a combination thereof may be moved. In practice, it is preferred to move the paste delivery device or at least a nozzle of the paste delivery device.

From U.S. Pat. No. 6,861,095 a method of forming a paste pattern is known in which the paste pattern is formed by drawing linear lines of paste on the body. The body on which the paste is applied is a leadframe and the paste is an adhesive to connect a bare semiconductor chip to the leadframe. The paste pattern consists of a number of segment lines wherein at least one of the segment lines consists of two written lines and wherein the start point and the end point of the drawing process are positioned other than the ends of the paste pattern.

This known method has several drawbacks which are explained below in detail with the aid of the two FIGS. 3B of U.S. Pat. No. 6,861,095 which are labeled as FIGS. 1 and 2 in the present description. The writing path shown in FIG. 1 as a white line on a black cross consists of a number of straight lines that cross each other. If no measures are taken, the nozzle of the paste delivery device will run into and through the already applied paste at the crossing points. Because of the high speed with which the writing patterns are written, the paste material to be traversed suddenly involves a large mechanical resistance to the nozzle, leading to an impact which can cause the nozzle and other parts of the system to vibrate. In addition, the paste material already applied is smeared, which may lead to the generation of air bubbles in the later manufacturing process. These air bubbles deteriorate the reliability of the resulting component, or may even lead to the failure of the component. Furthermore, the nozzle becomes soiled on the outside. As a result of the soiling, regular cleaning of the nozzle is necessary in order to achieve even quality during the continuous processing.

The writing path shown in FIG. 2 does not show this problem because it does not contain any crossing point. However, while the writing path shown in FIG. 1 contains only one sharp bend of 90°, the writing path shown in FIG. 2 contains three sharp 90° bends in the center of the cross. At each of these bends the writing speed must be braked down to nearly zero in order to realize the bend. The braking must not occur in a too jerky manner, which means over a too short distance, in order to avoid the generation of disturbing vibrations in the system. This need to slow down the speed considerably slows down the writing process and therefore strongly increases the time needed to write the writing pattern.

FIG. 3 shows another writing pattern known from the prior art. This writing pattern consists of 23 sections labeled from 1 through 23 which form a continuous writing path. The sections are straight sections and circular sections. The resulting paste pattern is shown in FIG. 4. At the transition points from such a linear section to such an arc of a circle, or vice-versa, the excitation of disturbing vibrations was noticed when a too high writing speed of the nozzle was maintained in the transitional region. This means that it is necessary to brake down the nozzle at these transition points in order to avoid or at least minimize the generation of disturbing vibrations.

### SUMMARY OF THE INVENTION

It is therefore an object of the invention to provide a writing method for paste patterns which allows the writing of complex patterns at high velocity without inducing disturbing vibrations by the writing process.

This object is achieved in accordance with the invention in that the paste pattern is formed on the surface of a body, which is for example a leadframe or a semiconductor chip, by moving a writing nozzle delivering the paste relatively to the surface of the body along a sequence of segment lines, wherein each segment line has a start point and an end point and at least one of the segment lines has at least a section with a curvature, said curvature changing continuously, and wherein said moving comprises stopping the writing nozzle at the end point of each segment line. The term “continuously” is to be understood as it is also used in mathematics with regard to continuous functions.

Preferably, the writing path is composed of straight segment lines and segment lines with at least one curved section wherein the curvature increases or decreases evenly along a distance that is as long as possible. Notably, a straight section is a section without curvature.

The writing path according to the invention has no transitions from a straight section to a circular section as in the prior art. Therefore no sudden change from a straight section with a curvature equal to zero to an arc of a circle with a constant curvature different from zero occurs. As a result, the centrifugal force builds up softly and decreases softly and thus jolts resulting from a sudden change in the centrifugal force and disturbing vibrations resulting from the jolts are avoided.

In order to additionally overcome the generation of vibrations and the smearing of the paste caused by segment lines crossing each other, the nozzle is lifted to a higher distance above the surface of the body whenever an already written segment line is to be crossed and is lowered again afterwards. However, it is preferred to use writing patterns that do not have any segment lines that cross each other.

### BRIEF DESCRIPTION OF THE DRAWING FIGURES

The accompanying drawings, which are incorporated into and constitute a part of this specification, illustrate one or more embodiments of the prior art and of the present invention and, together with the detailed description, serve to explain the principles and implementations of the invention. The figures are not shown true to scale. In the drawings:

FIG. 1 shows a first paste pattern having the form of a cross and a writing path for making the paste pattern according to the prior art,

FIG. 2 shows the first paste pattern and another writing path according to the prior art,

FIG. 3 shows a writing path according to the prior art for making a paste pattern having the form of a “Double Y”,

FIG. 4 shows the “Double Y” paste pattern resulting from the writing path according to FIG. 3,

FIG. 5 shows a writing path according to the invention for making a paste pattern having the form of a cross,

FIG. 6 shows a writing path according to the invention for making a paste pattern having the form of a “Double Y”,

FIG. 7 illustrates the writing of a path having a segment line crossing another segment line,

FIG. 8 shows the progression of the curvature according to the prior art,

FIG. 9 shows the progression of the curvature according to a first embodiment of the invention, and

FIG. 10 shows a progression of the curvature according to a preferred embodiment of the invention.

### DETAILED DESCRIPTION OF THE INVENTION

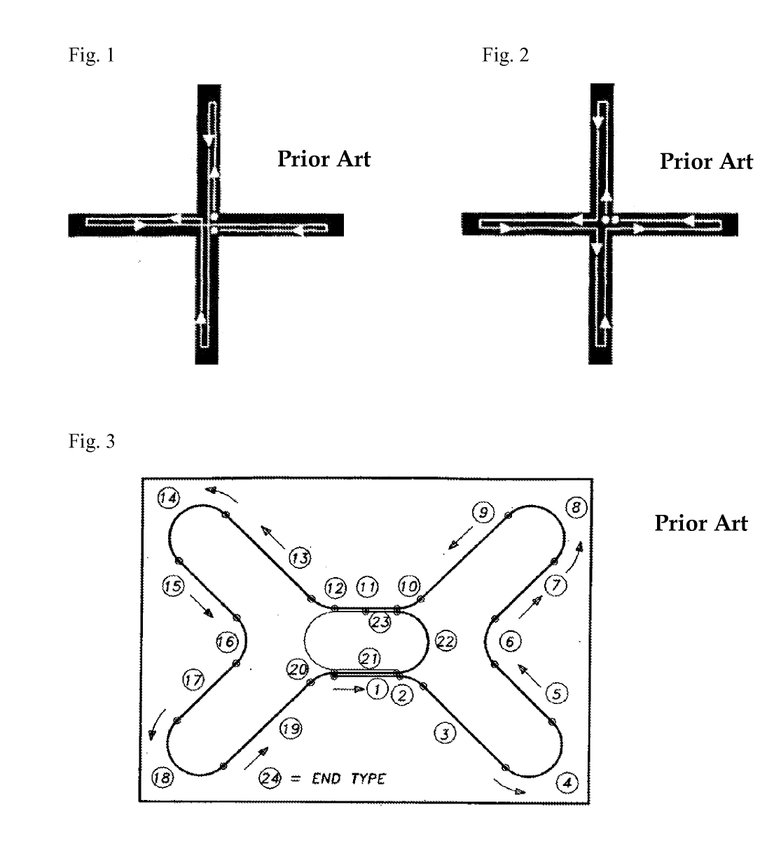

FIGS. 1 to 3 show writing paths of the prior art that have been discussed above and do not need to be explained any further.

FIG. 5 shows a writing path according to the invention for producing a paste pattern 1 having the form of a cross. The resulting paste pattern 1 is shown as a hatched area. The writing path has a start point 2 and an end point 3 located near the center of the cross. The writing path consist of a sequence of five segment lines 4 to 8 which are written one after the other. Each segment line has a start point and an end point, wherein an end point of a segment line is also the start point of the next segment line. The start point of the first segment line 4 and the end point of the last segment line 8 lie near the center of the paste pattern 1. All the other start points and end points of all segment lines each lie at a peripheral point of the paste pattern 1. In this example the five segment lines 4 to 8 can be characterized as follows: The first segment line 4 is a straight line. The second segment line 5 consists of three sections, namely a straight section 5A which is followed by a curved section 5B which is followed by another straight section 5C. The third segment line 6 is a straight line. The fourth segment line 7 consists of three sections like the second segment line 5. The fifth segment line 8 is like the first segment line 4 a straight line. The curvature of the curved section 5B of the second segment line 5 as well as the curvature of the curved section of the fourth segment line 7 start with zero, increase continuously, optionally remain constant over a certain distance, decrease continuously and end again with zero. As can be seen in FIG. 5 the end section of a segment line and the beginning section of the next segment line preferably include an acute angle, meaning that the direction of movement is not reversed by exactly 180°, but a little bit less.

For writing the paste pattern the nozzle is moved along the writing path, starting at the start point 2. For each of the segment lines 4 to 8, the speed of the nozzle is first increased (from zero) and later decreased down to zero so that the nozzle comes to stop at the end point of the segment line. At this point the direction of movement of the nozzle essentially reverses. Optionally, the movement direction of the nozzle is not only reversed, but the nozzle is stopped for a period of some milliseconds.

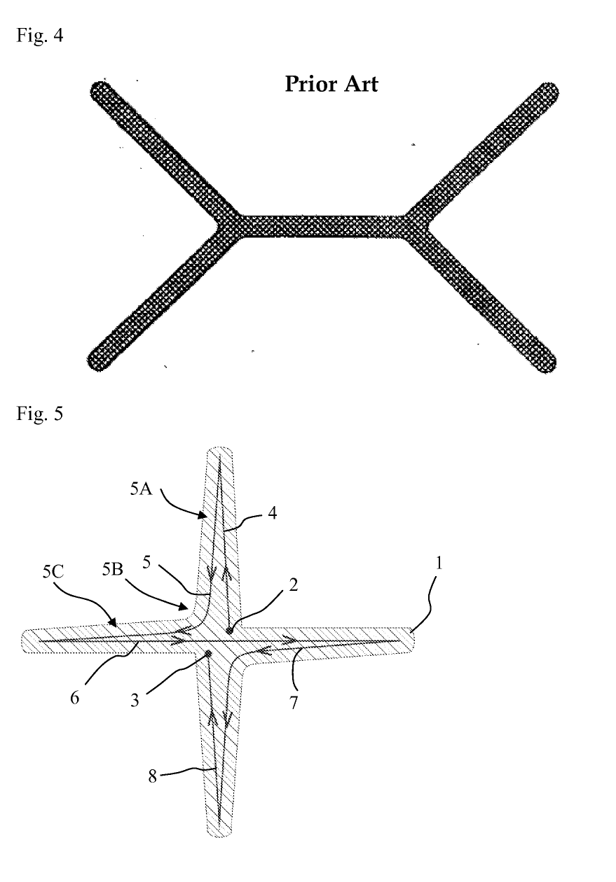

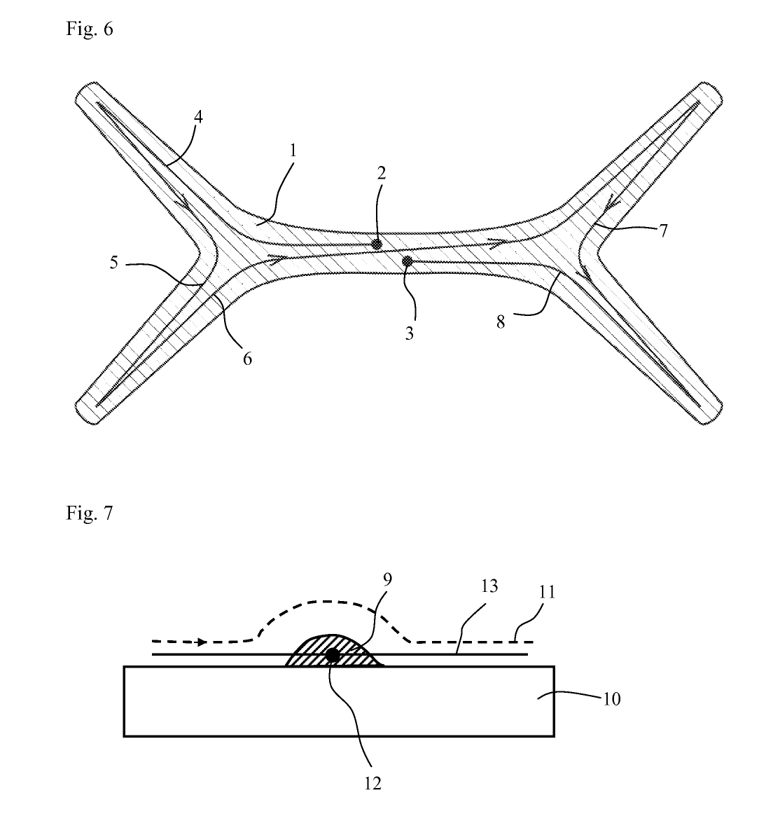

FIG. 6 shows a writing path according to the invention for producing a paste pattern 1 having the form of a so called “Double Y” as shown in FIG. 4. In this example, the writing path consists also of a sequence of five segment lines 4 to 8 following one after the other. The four segment lines 4, 5, 7 and 8 begin with a straight section which is followed by a curved section which is followed again by a straight section. The third segment line 6 consists of a straight section followed by a first curved section followed by a middle straight section followed by a second curved section and followed by another straight section. The middle straight section may be omitted so that the second curved section directly follows the first curved section. For writing the paste pattern the nozzle is moved along the writing path as described in the previous paragraph.

While each of the segment lines 4 to 8 of the writing paths shown in FIGS. 5 and 6 contains at least one straight section or is a straight line, the segment lines may also be segment lines that are curved along their whole length. In this case, in the simplest form, the curvature of the segment line increases from the beginning continuously from zero, reaches a maximum, and decreases again continuously, either to zero or to a value that is not zero. The curvature does not need to be zero at the end point of a segment line because there the movement of the nozzle is stopped anyway.

The segment lines of the writing paths shown in FIGS. 5 and 6 do not cross each other. While this is preferred, it may nonetheless occur that two segment lines cross each other. In this case it is preferred to raise the writing nozzle to a slightly higher distance from the surface of the body before the segment line crosses the other segment line and lower the writing nozzle again after the crossing. FIG. 7 illustrates this procedure. FIG. 7 shows paste 9 deposited on the surface of a body, the paste 9 having been deposited by moving the nozzle along a segment line 12 that runs perpendicularly or obliquely to the plane of the drawing. The dashed line 11 shows the distance between the tip of the nozzle and the surface of the body when the nozzle is moved along another segment 13 line that crosses the already written segment line 12.

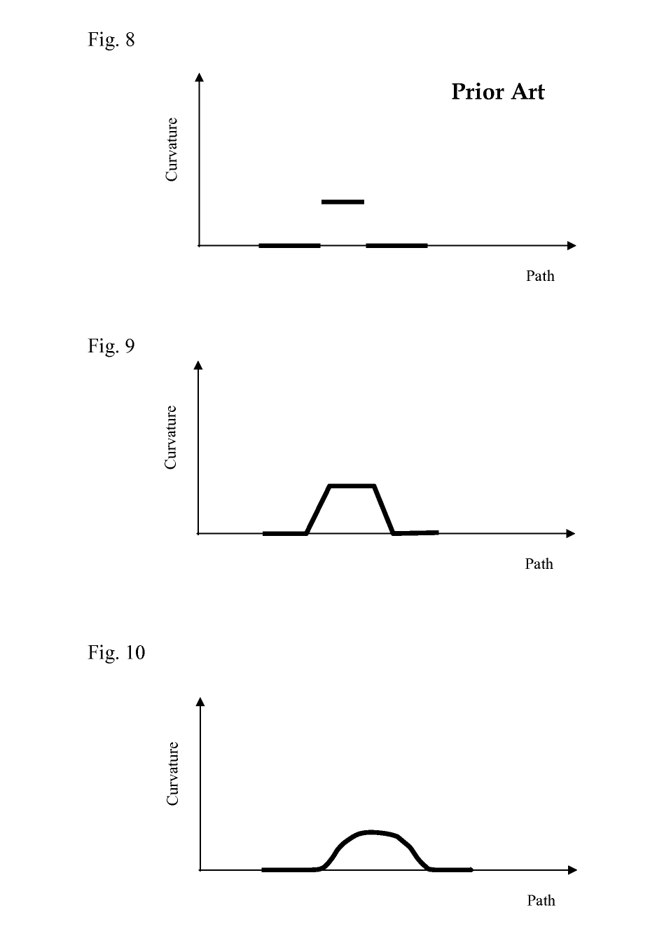

For further illustration of the invention, FIGS. 8 to 10 show the progression of the curvature for the following cases: FIG. 8 shows the curvature along the straight section 3, the curved section 4 and the straight section 5 of the writing path shown in FIG. 3. The curvature is zero within the straight sections 3 and 5 and has a constant value different from zero within the curved section 4. This is the behavior of the curvature according to the prior art. In contrast to this, FIG. 9 shows a possible progression of the curvature along a segment line having a curved section in accordance with the invention: Whenever the curvature changes it changes continuously, i.e. the line representing the curvature has no discontinuous points where the value of the curvature changes abruptly from one value to a different value. FIG. 10 shows a preferred progression of the curvature along a segment line having a curved section in accordance with the invention: The line representing the curvature is a function that is not only continuous, but can be differentiated.

Generally, the nozzle is moved relative to the surface of the body in two directions which may be called x-direction and y-direction. Moving the nozzle along a curved section means that the nozzle needs to be accelerated in the x-direction and/or in the y-direction. A continuous change of the curvature according to the invention is therefore equivalent to a continuous change of the accelerations of the nozzle in the x-direction and/or in the y-direction.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. Method of forming a paste pattern on a surface of a body, comprising
moving a writing nozzle delivering the paste relatively to the surface of the body along a sequence of segment lines following each other, each segment line having a start point and an end point and at least one of the segment lines having a section with a curvature, wherein said moving comprises stopping the writing nozzle at the end point of each segment line and wherein the curvature of each segment line having a section with a curvature changes continuously.

2. Method according to claim 1, wherein the curvature of at least one segment line having a section with a curvature is differentiable.

3. Method according to claim 1, further comprising raising the writing nozzle relatively to the surface of the body before the nozzle crosses an already written segment line and lowering the writing nozzle after said crossing.

4. Method according to claim 2, further comprising raising the writing nozzle relatively to the surface of the body before the nozzle crosses an already written segment line and lowering the writing nozzle after said crossing.
